(19) United States
(12) Patent Application Publication
(10) Pub. No.: US 2013/0346917 A1
(43) Pub. Date: Dec. 26, 2013

(54) CLIENT APPLICATION ANALYTICS

(71) Applicants: ANDREW BRAGDON, REDMOND, WA (US); PAULA BACH, REDMOND, WA (US); CURT BECKER, EUGENE, OR (US); ARUN MATHEW ABRAHAM, REDMOND, WA (US); ANNA GALAEVA, REDMOND, WA (US); MARK GROVES, MONROE, WA (US)

(72) Inventors: ANDREW BRAGDON, REDMOND, WA (US); PAULA BACH, REDMOND, WA (US); CURT BECKER, EUGENE, OR (US); ARUN MATHEW ABRAHAM, REDMOND, WA (US); ANNA GALAEVA, REDMOND, WA (US); MARK GROVES, MONROE, WA (US)

(73) Assignee: Microsoft Corporation, Redmond, WA (US)

(21) Appl. No.: 13/530,119

(22) Filed: Jun. 22, 2012

(51) Int. Cl. G06F 3/048

(52) U.S. Cl. 715/802

(57) ABSTRACT

A sequence of user actions is generated from a runtime trace of a client application that is analyzed against a set of detectors to infer a feature-level usage analytic. The feature-level usage analytic identifies a common trait among the various users that use a feature of the application and is used as a basis to reflect the user's experience with the feature. The feature-level usage analytic may be a level of the user's ability with the application or an application state that indicates an outcome of a group of users' usage with a particular feature. The feature-level usage analytic provides a developer with insight into the user's behavior when using the application.

### BACKGROUND

In order to analyze the runtime behavior of a software application, software developers often use a tool to trace events occurring during the execution of the software application. The trace provides the developer with quantitative measurements of the runtime behavior of the software application such as the number of times a crash occurs, the number of times a user clicks on a certain button, the amount of space available on a hard disk drive, and so forth. The quantitative measurements may then be used to identify coding errors and to detect bottlenecks that affect the performance of the software application. However, the quantitative measurements are not well suited to understand the user's behavior in using the application and the rationale for such behavior.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A qualitative analysis of an application is performed in order to gain insight into the usefulness of one or more features of the application. The qualitative analysis is performed using a runtime trace of the user actions that a group of users make when using the feature. The user actions may be command invocations and/or window focus changes that a user makes while engaging a feature of interest. One or more detectors are used to compare a sequence of user actions against known patterns of user actions. When a sequence of user actions matches a known pattern, a feature-level usage analytic is associated with the sequence. A feature-level usage analytic identifies a common trait amongst a group of users that perform the same sequence of user actions. A feature-level usage analytic may be a level of the user's ability or an adoption state. An adoption state is an outcome that results from the user's usage of a feature.

Statistical analysis may be performed on the sequences of user actions and the feature-level usage analytics in order to infer the user's behavior with respect to a feature of interest. In this manner, a developer understands whether or not the feature was useful and how the application may be tailored to better suit the needs of the user community.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF DRAWINGS

FIG. 1 illustrates an exemplary system for qualitatively analyzing the usage of a client application.

FIG. 2 is an exemplary illustration of the process of qualitatively analyzing a client application from various sequences of user actions.

FIG. 3 is a flow diagram illustrating an exemplary method of qualitatively analyzing the usage of a client application.

FIGS. 4-11 are flow diagrams illustrating exemplary detectors.

FIG. 12 is a block diagram illustrating an operating environment.

FIG. 13 is a block diagram illustrating an exemplary client device.

FIG. 14 is a block diagram illustrating an exemplary server device.

### DETAILED DESCRIPTION

Various embodiments are directed to a technology for performing a qualitative analysis of an application in order to gain insight into the usefulness of one or more features of the application. The qualitative analysis is performed using a runtime trace of user actions that utilize a particular feature of the application. The runtime trace includes sequence of user actions recorded while the user uses the application. Detectors associated with known patterns of user actions are used to match a sequence of user actions with the known patterns. When a sequence of user actions matches a known pattern, a corresponding feature-level usage analytic is associated with the sequence. The feature-level usage analytic may be an application state, a level of the user's ability with the application, and so forth. The application state indicates a completion status of a usage of the feature which may be used to reflect the result of the user's experience with the feature. In this manner, a developer understands whether or not the feature was of use to the users and the ability of the users with the application so that the application may be tailored accordingly.

In one or more embodiments, the application may be an integrated development environment. An integrated development environment enables a user (e.g., developer, programmer, etc.) to write, execute, debug, test, visualize, and edit a software application. The integrated development environment offers a user various features that the user may utilize in the course of developing a software application. In order to get insight into the usefulness of a feature, the user's actions during application development are monitored by an instrumentation tool.

The instrumentation tool generates a user interaction log file that captures certain user actions. In one or more embodiments, the user actions may include command invocations and window focus actions made by a user during the user's session with the integrated development environment. User interaction log files, from various users, are then collected and analyzed to gain insight into the manner in which users utilize specific features within the integrated development environment.

Detectors are used to analyze a sequence of user actions. In one or more embodiments, the detectors are programs that match a sequence of user interactions to a feature-level usage analytic. Analysis of the feature-level usage analytics across a wide variety of users provides insightful feedback of the users' behavior with respect to a feature which may be used to improve the application. Attention now turns to a discussion of an exemplary system embodying this technology.

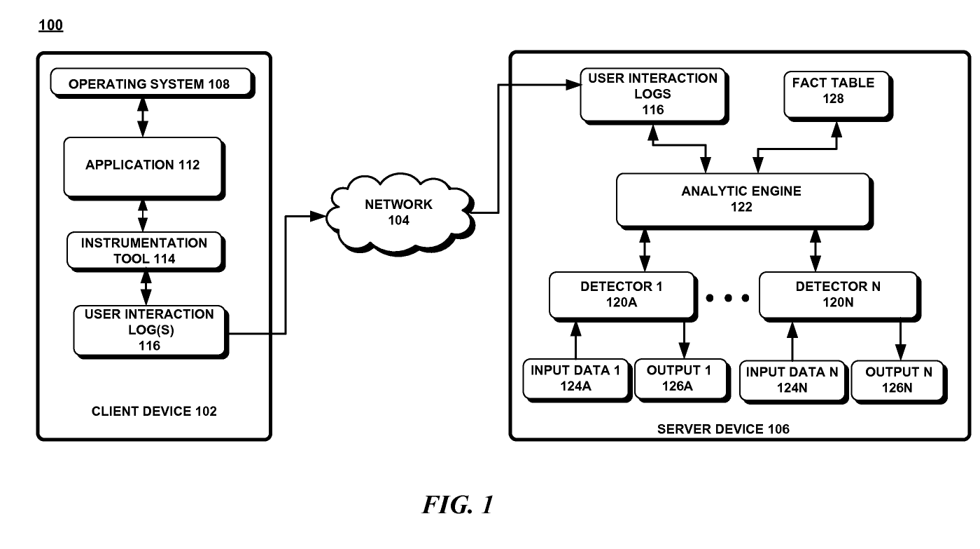

FIG. 1 illustrates a block diagram of an exemplary system for qualitatively analyzing a client application. The system 100 may include a client device 102 and a server device 106 communicatively coupled through a network 104. Although the system 100 as shown in FIG. 1 has a limited number of elements in a certain topology, it may be appreciated that the system 100 may include more or less elements in alternate topologies as desired for a given implementation.

The client device 102 and the server device 106 may be any type of computing device capable of executing programmable instructions such as, without limitation, a mobile device, a personal digital assistant, a mobile computing device, a smart phone, a cellular telephone, a handheld computer, a server, a server array or server farm, a web server, a network server, an Internet server, a work station, a mini-computer, a mainframe computer, a supercomputer, a network appliance, a web appliance, a distributed computing system, multiprocessor systems, or combination thereof.

The network 104 may be any type of communications link capable of facilitating communications between the client device 102 and the server device 106, utilizing any communications protocol and in any configuration, such as without limitation, a wired network, wireless network, or combination thereof.

The client device 102 may include an operating system 108, an application 112, an instrumentation tool 114 and one or more user interaction logs 116. The operating system 108 manages the hardware and software resources of the client device 102.

The application 112 is a sequence of computer program instructions, that when executed by a processor, causes the processor to perform methods and/or operations in accordance with a prescribed task. The application 112 may be implemented as program code, programs, procedures, module, code segments, program stacks, middleware, firmware, methods, routines, and so on. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

In one or more embodiments, the application 112 may be an integrated development environment (“IDE”). An IDE may be a software application that contains a set of resources and tools for use in developing and testing software applications. In addition, the integrated development environment may include tools to edit, execute, and test the application. For example, the integrated development environment may include one or more compilers, an editor, one or more interpreters, and libraries. In one or more embodiments, the integrated development environment may be Microsoft's Visual Studio®. However, the embodiments are not limited to Visual Studio® and other integrated development environments may embody the techniques described herein such as without limitation, Eclipse, NetBeans, etc.

The instrumentation tool 114 monitors the execution of the application 112 to record an instruction or data trace of the application 112. The instrumentation tool 114 may be configured to monitor the occurrence of certain events which trigger the recordation of the trace. There are various types of instrumentation tools that may be used such as, without limitation, the Microsoft® Enterprise Instrumentation Framework, Windows® Management Instrumentation, and the like. It should be noted that the embodiments are not limited to any particular type of instrumentation tool.

In one or more embodiments, the instrumentation tool 114 may be configured to trace command invocations and window focus events initiated by the user while using the integrated development environment. A command invocation is the execution of a command within the integrated development environment. A window focus event is a user action that generates or alters the window that is currently in focus on a display. The instrumentation tool 114 outputs the trace of each user's action that corresponds to a command invocation and a window focus event into a user interaction log 116.

In one or more embodiments, a user interaction log 116 may be configured as a single file that captures the traced data for all users, during all user sessions, on a particular client device. In other embodiments, there may be a separate user interaction log 116 for each user. The embodiments are not limited to a particular configuration of the user interaction log 116. In either case, each user interaction log 116 may be transmitted to a server device 106 for further analysis.

The server device 106 may include one or more user interaction logs 116, one or more detectors, detector 1-detector N, 120A-120N (collectively, ‘120’), an analytic engine 122, and a fact table 128. A detector 120 is a computer program that maps a sequence of user actions into a feature-level usage analytic. Each detector 120 may receive input data 124A-124N (collectively, ‘124’) and may generate output, output 1-output N, 126A-126N (collectively, ‘126’). The input data 124 may include a list of commands that are considered expert level, a list of commands that are considered novice level, and/or additional runtime trace data that may not be included in the user interaction logs 116. The server device 106 receives user interaction logs 116 from multiple client devices 102 which may be stored in the server device 106.

An analytic engine 122 may be used to analyze each user interaction log 116 with respect to the set of detectors 120 to formulate the fact table 128. The fact table 128 is a data structure that contains a tabulated listing of each user action configured in a prescribed manner. The analytic engine 122 uses the fact table 128 to formulate a sequence of user actions for each user. The sequence of user actions is then compared against one or more detectors 120 to determine a feature-level usage analytic. The sequence of user actions and the results may be output for further analysis.

The output 126 may be stored in the server device 106 and implemented in various forms. The output 126 may be a database storing the sequence of user actions along with statistical data for each feature-level usage analytic. The output 126 may also be a visual representation of the results in the form of a funnel, a bar chart, a graph, and so forth.

Although the system 100 shown in FIG. 1 has a limited number of elements in a certain configuration, it should be appreciated that the system 100 can include more or less elements in alternate configurations. For example, the server device 106 may be arranged as a plurality of server machines or configured as a combination of server and client machines. The instrumentation tool 114 may be part of the operating system, a standalone software application, part of the integrated development environment, or configured in any other manner. In some embodiments, the client device 102 and the server device 106 may be implemented in the same computing device. The embodiments are not limited in this manner.

In various embodiments, the system 100 described herein may comprise a computer-implemented system having multiple elements, programs, procedures, modules. As used herein, these terms are intended to refer to a computer-related entity, comprising either hardware, a combination of hardware and software, or software. For example, an element may be implemented as a process running on a processor, a hard disk drive, multiple storage drives (of optical and/or magnetic storage medium), an object, an executable, a thread of execution, a program, and/or a computer. By way of illustration, both an application running on a server and the server may be an element. One or more elements may be integrated within a process and/or thread of execution, and an element may be localized on one computer and/or distributed between two or more computers as desired for a given implementation. The embodiments are not limited in this manner

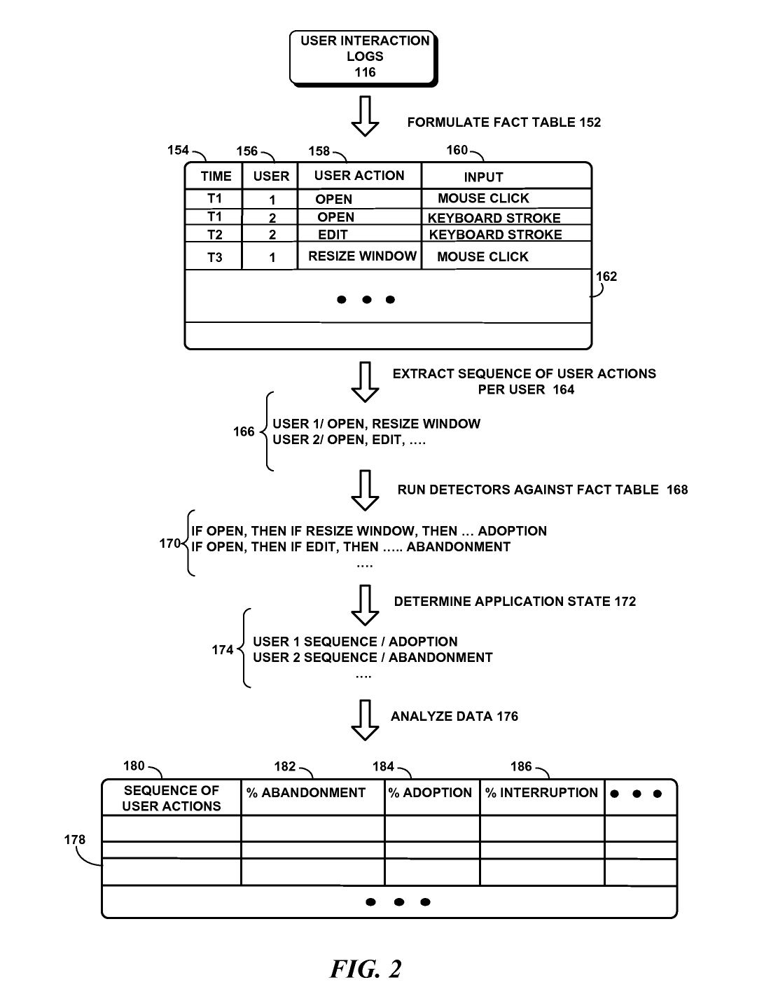

FIG. 2 is an exemplary illustration of the process of analyzing the usage of a client application. It should be noted that the process depicted in FIG. 2 is for illustration purposes only and that the embodiments are not limited to the configuration of elements and processes shown in FIG. 2.

The analytic engine 122 may read one or more user interaction logs 116 from which the fact table is formulated (step 152). The fact table 162 may be constructed in a tabular format having a row for each user action made at a particular time. As shown in FIG. 2, the fact table 162 may be configured to include a time unit (“time”) 154, an identifier that represents a user anonymously (“user”) 156, a user action (“user action”) 158 that describes the command invocations and window focus changes and an input that initiated the user action (“input”) (e.g., keyboard stroke, mouse click, screen touch, etc.) 160.

As shown in FIG. 2, the fact table 162 may show, at time T1, that user 1 may have initiated an open command through a mouse click. At time T1 user 2 may have also initiated an open command through a keyboard stroke. At time T2, user 2 may have initiated an edit command through a keyboard stroke and at time T3, user 1 may be initiated a resize window command through a mouse click.

The analytic engine 122 reads the fact table 162 and extracts a sequence of user actions for each user (step 164). For example, for user 1, the sequence of user actions may include open, resize window, and so forth. For user 2, the sequence of user actions may include open, edit, and so forth.

The analytic engine 122 initiates the detectors. Each detector is used to compare each sequence of user actions, in the fact table, against known patterns (steps 168-170) to associate a sequence with a particular feature-level usage analytic (steps 172-174). For example, if a sequence of user actions consists of an open command followed by a resize window, then the detector may infer that the application state is adoption (steps 170-174). By way of another example, if a sequence of user actions consists of an open command followed by other commands not related to the feature of interest, then the detector may infer that the application state is abandonment (steps 170-174).

The sequence of user actions and application states may be stored and retrieved at a later point in time for further analysis. The analytic engine 122 may perform a statistical analysis on the sequence of user actions with respect to the adoption states. The output 126 of the analysis may be presented in a table 178 shown in FIG. 2. The table 178 may include a row for each sequence of user actions with a corresponding set of statistical measurements. The statistical measurements may include a percentage that a particular sequence of user actions 180 results in a particular application state. For example, the percentage that the sequence of user actions 180 results in abandonment 182 (“% abandonment”), the percentage that a sequence results in adoption 184 (“% adoption”), the percentage that a sequence results in interruption 186 (“% interruption”), and so forth.

Attention now turns to a discussion of the operations for the embodiments with reference to various exemplary methods. It may be appreciated that the representative methods do not necessarily have to be executed in the order presented, or in any particular order, unless otherwise indicated. Moreover, various activities described with respect to the methods can be executed in serial or parallel fashion, or any combination of serial and parallel operations. The methods can be implemented using one or more hardware elements and/or software elements of the described embodiments or alternative embodiments as desired for a given set of design and performance constraints. For example, the methods may be implemented as logic (e.g., computer program instructions) for execution by a logic device (e.g., a general-purpose or specific-purpose computer).

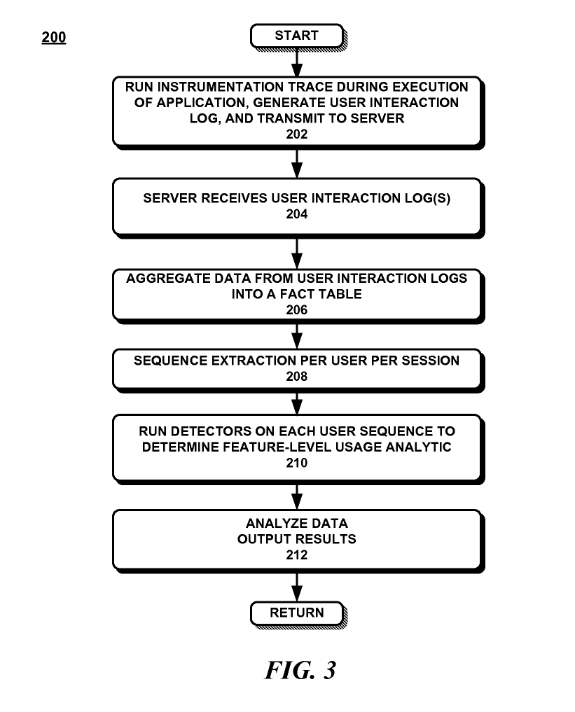

FIG. 3 illustrates a flow diagram of an exemplary method for analyzing client application analytics. It should be noted that the method 200 may be representative of some or all of the operations executed by one or more embodiments described herein and that the method can include more or less operations than that which is described in FIG. 3.

At a client device 102, the execution of an application 112 may be traced through an instrumentation tool 114 (block 202). In one or more embodiments, the instrumentation tool 114 may trace command invocations and window focus changes made by a user while using the application 112 (block 202). The traced data is output to a user interaction log 116 which is then transmitted to a server device 106 (block 202).

The server device 106 receives several user interaction logs 116 from one or more client devices 102 (block 204). The analytic engine 122 aggregates the data from the user interaction logs 116 and formats the aggregated data into a fact table 128 (block 206). The analytic engine 122 then reads the fact table 128 to extract a sequence of user actions for each user during a single session (block 208). The sequence of user actions is analyzed by one or more detectors (block 210). When a detector indentifies a sequence, a feature-level usage analytic is associated with the sequence (block 210). The sequence and its application state may be stored in the server device 106 (block 210). At a later point in time, the analytic engine 122 may analyze the stored sequences and feature-level usage analytic in a prescribed manner which may be output to a developer in an intended manner (block 212).

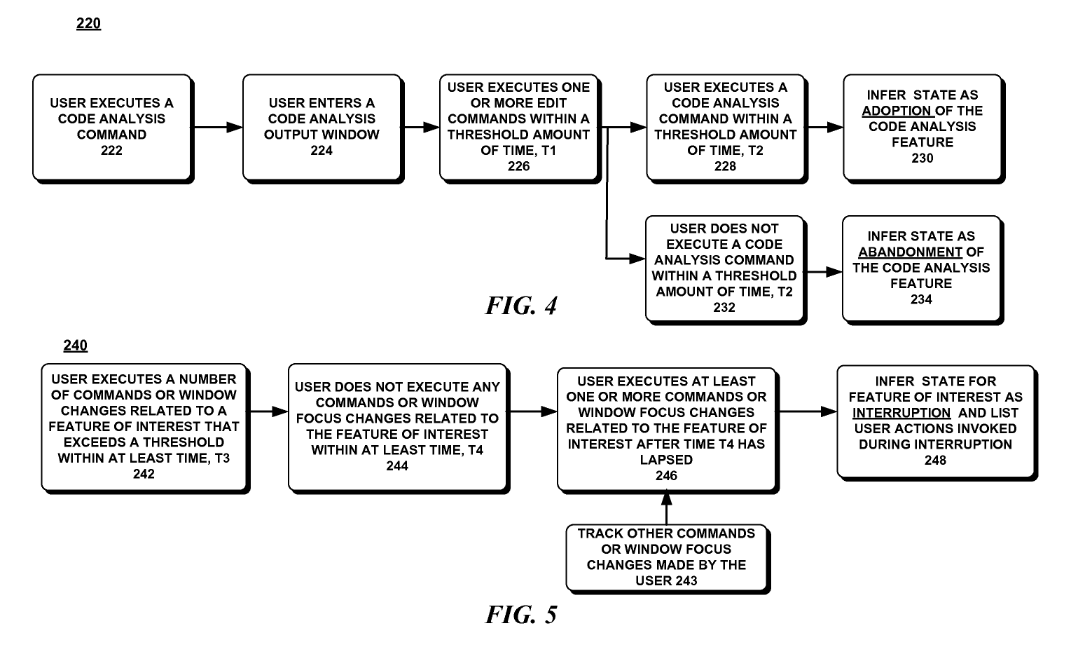

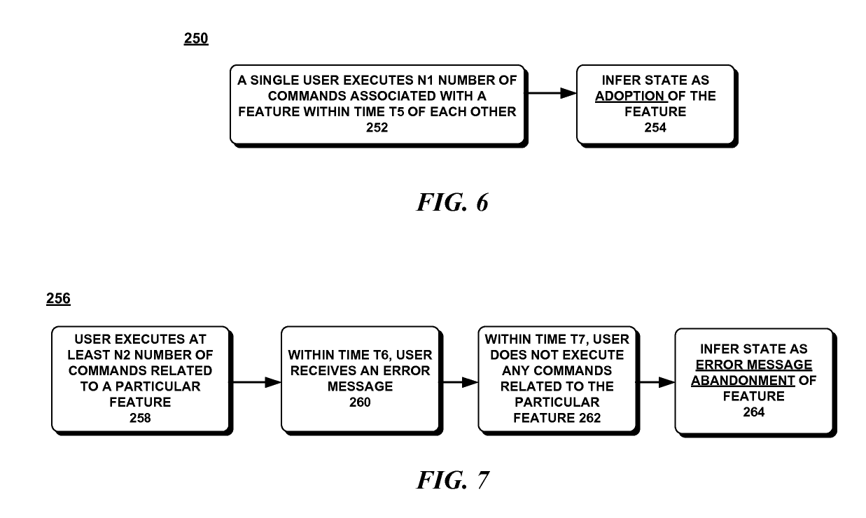

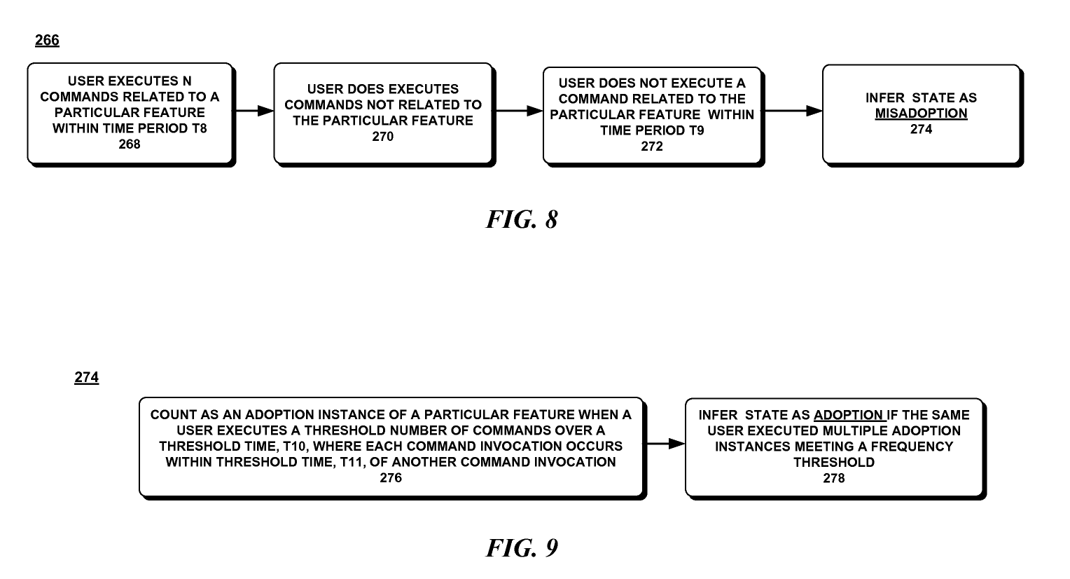

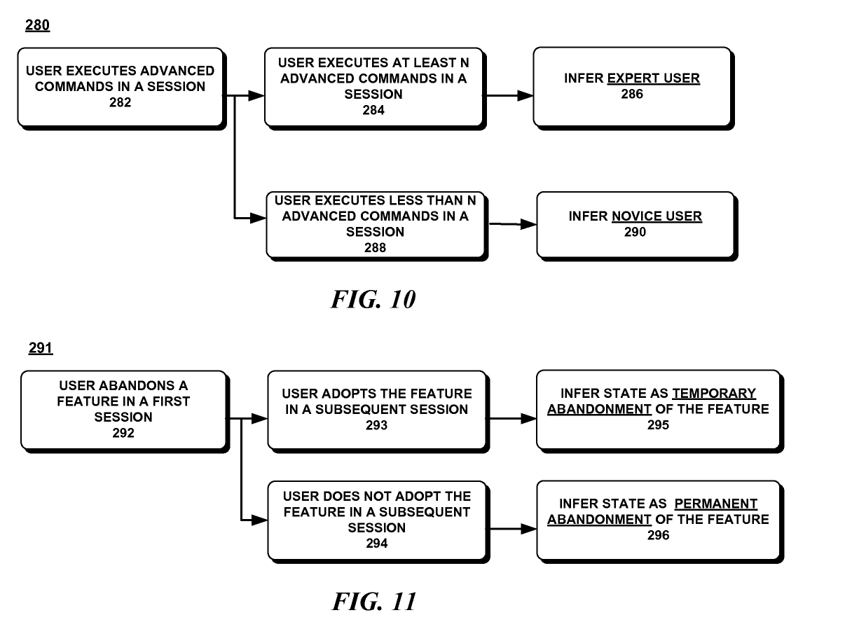

Attention now turns to a discussion of the detectors. FIG. 4 illustrates a detector that analyzes a code analysis feature to determine whether the code analysis feature is adopted or abandoned by a user. FIG. 5 illustrates a detector that infers an application state of interruption and which lists the user actions that the user invoked during the interruption. FIG. 6 illustrates a detector that infers an application state of adoption. FIG. 7 illustrates a detector that infers an application state of error message abandonment. FIG. 8 illustrates a detector that infers an application state of misadoption. FIG. 9 illustrates a detector that infers an application state of adoption based on a count of adoption instances. FIG. 10 illustrates a detector that determines a level of the user's ability with the application. FIG. 11 illustrates a detector that infers an application state of temporary or permanent abandonment.

Turning to FIG. 4, detector 220 infers the application state of adoption of the code analysis feature (block 230) when the sequence of user actions consists of the following: a user executing a code analysis command (block 222); followed by the user entering a code analysis output window (block 224); followed by the user executing one or more edit commands within a threshold amount of time, T1 (block 226); and followed by the user executing a code analysis command within a threshold amount of time, T2 (block 228).

Detector 220 infers the application state of abandonment of the code analysis feature (block 234) when the sequence of user actions consists of the following: a user executing a code analysis command (block 222); followed by the user entering a code analysis output window (block 224); followed by the user executing one or more edit commands within a threshold amount of time, T1 (block 226); and followed by the user not executing a code analysis command within a threshold amount of time, T2 (block 232).

Turning to FIG. 5, detector 240 infers the application state of interruption (block 248) when the sequence of user actions consists of the following: a user executing a number of commands that exceeds a threshold amount within at least time, T3 (block 242); followed by the user not executing any commands or window focus changes within at least time T4 (block 244); and followed by the user executing at least one or more commands or window focus changes after time T4 has lapsed (block 246). The detector 240 uses input data 124 that tracked commands or window focus changes made by the user during the interruption (block 243). In addition to inferring the application state of interruption, the detector 240 lists the user actions that were invoked during the interruption (block 248). The list of user actions invoked during the interruption may be used by a developer to determine the user's behavior during the interruption.

Turning to FIG. 6, detector 250 infers the application state of adoption (block 254) when the sequence of user actions consists of a single user executing N1 number of commands associated with a particular feature within time T5 of each command invocation (block 252).

Turning to FIG. 7, detector 256 infers the application state of error message abandonment (block 264) when the sequence of user actions consists of the following: a user executing at least N2 number of commands related to a particular feature (block 258); followed by, within time T6, a user receiving an error message (block 260); and followed by, within time T7, a user not executing any commands related to the particular feature (block 262).

Turning to FIG. 8, detector 266 infers the application state of misadoption (block 274) when the sequence of user actions consists of the following: a user executes N commands that relate to a particular feature within time period T8 (block 268); followed by the user executing certain commands not related to the particular feature (block 270); and followed by the user not executing a command related to a particular feature within time period T9 (block 272).

FIG. 9 illustrates a detector 274 that infers the application state of adoption based on a count of adoption instances. An adoption instance occurs when a user executes a threshold number of commands related to a feature over a threshold amount time and where each command invocation occurs within another threshold amount of time between successive command invocations. Turning to FIG. 9, detector 274 infers the application state of adoption if a single user has executed a threshold amount of adoption instances (block 278). Detector 274 counts as an adoption instance of a particular feature, when a user executes a threshold amount of commands within a threshold time, T10, where each command invocation occurs within threshold T11 amount of time between each command invocation (block 276).

FIG. 10 illustrates a detector 280 that infers a level of the user's ability with the application. The detector 280 may receive input data 124 that may include a list of expert level commands and novice level commands and a sequence of user actions that are advanced commands performed in a session (block 282). The detector infers a level of expert user (block 286) when the user executes at least N number of advanced commands in a session (block 284) and infers a novice user (block 290) when the user executes less than N number of advanced commands in a session (block 288).

Turning to FIG. 11, detector 291 infers the application state of temporary abandonment of the feature (block 295) when the sequence of user actions consists of the following: a user abandons a feature in a first session (block 292) and a user adopts the feature in a subsequent session (block 293). Detector 291 infers the application state of permanent abandonment of the feature (block 296) when the sequence of user actions consists of the following: a user abandons a feature in a first session (block 292) and a user does not adopt the feature in a subsequent session (block 294).

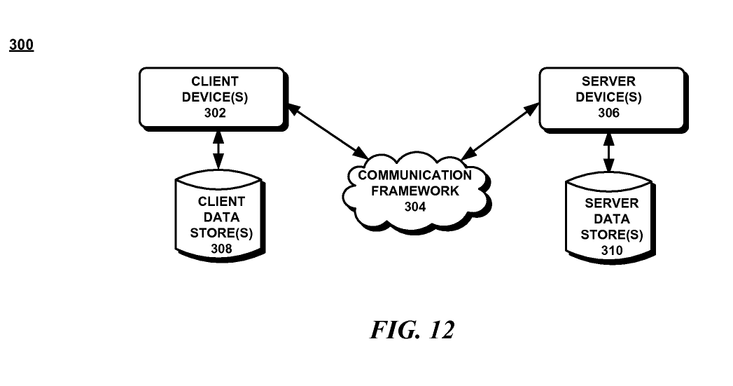

Attention now turns to a discussion of an exemplary operating environment. FIG. 12 illustrates a first operating environment 300. It should be noted that the operating environment 300 is exemplary and is not intended to suggest any limitation as to the functionality of the embodiments. The embodiment may be applied to an operating environment 300 having one or more client device(s) 302 in communication through a communications framework 304 with one or more server device(s) 306. The operating environment 300 may be configured in a network environment, a distributed environment, a multiprocessor environment, or a stand-alone computing device having access to remote or local storage devices.

A client device 302 may be embodied as a hardware device, a software module, or as a combination thereof. Examples of such hardware devices may include, but are not limited to, a computer (e.g., server, personal computer, laptop, etc.), a cell phone, a personal digital assistant, or any type of computing device, and the like. A client device 302 may also be embodied as a software module having instructions that execute in a single execution path, multiple concurrent execution paths (e.g., thread, process, etc.), or in any other manner

A server device 306 may be embodied as a hardware device, a software module, or as a combination thereof. Examples of such hardware devices may include, but are not limited to, a computer (e.g., server, personal computer, laptop, etc.), a cell phone, a personal digital assistant, or any type of computing device, and the like. A server device 306 may also be embodied as a software module having instructions that execute in a single execution path, multiple concurrent execution paths (e.g., thread, process, etc.), or in any other manner.

The communications framework 304 facilitates communications between the client devices 302 and the server devices 306. The communications framework 304 may embody any well-known communication techniques, such as techniques suitable for use with packet-switched networks (e.g., public networks such as the Internet, private networks such as enterprise intranet, and so forth), circuit-switched networks (e.g., the public switched telephone network), or a combination of packet-switched networks and circuit-switched networks (with suitable gateways and translators).

A client device 302 and a server device 306 may include various types of standard communication elements designed to be interoperable with the communications framework 304, such as one or more communications interfaces, network interfaces, network interface cards, radios, wireless transmitters/receivers, wired and/or wireless communication media, physical connectors, and so forth. Examples of wired communications media may include a wire, cable, metal leads, printed circuit boards, backplanes, switch fabrics, semiconductor material, twisted-pair wire, coaxial cable, fiber optics, a propagated signal, and so forth. Examples of wireless communications media may include acoustic, radio frequency spectrum, infrared, and other wireless media.

Each client device 302 may be coupled to one or more client data store(s) 308 that store information local to the client device 302. Each server device 306 may be coupled to one or more server data store(s) 310 that store information local to the server device 306.

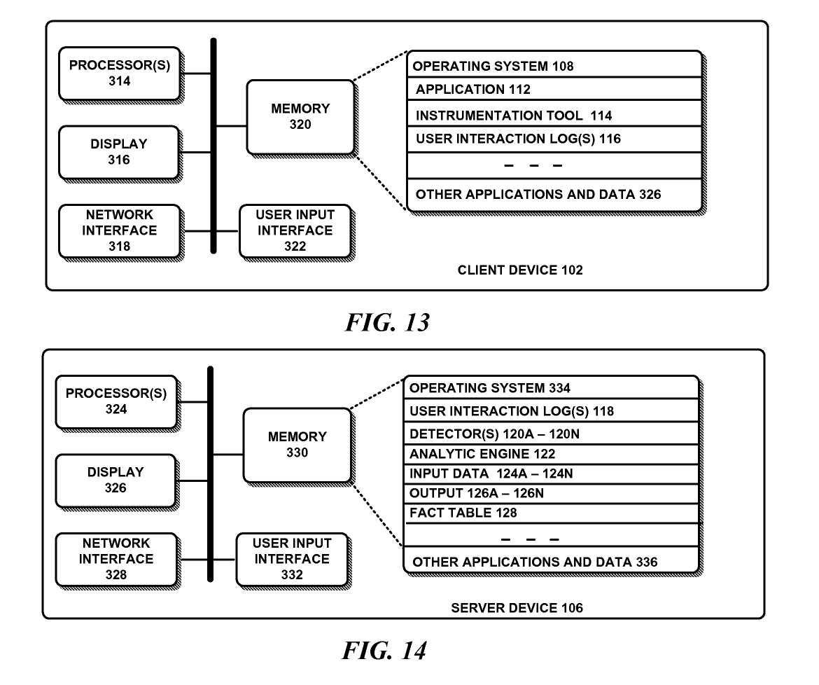

FIG. 13 illustrates a block diagram of an exemplary client device 102. The client device 102 may have one or more processors 314, a display 316, a network interface 318, a memory 320, and a user input interface 322. A processor 314 may be any commercially available processor and may include dual microprocessors and multi-processor architectures. The display 316 may be any type of visual display unit. The network interface 318 facilitates wired or wireless communications between a client device 102 and a communications framework. The user input interface 322 facilitates communications between the client device 102 and input devices, such as a keyboard, mouse, etc.

The memory 320 may be any computer-readable storage media that may store executable procedures, applications, and data. The computer-readable media does not pertain to propagated signals, such as modulated data signals transmitted through a carrier wave. It may be any type of memory device (e.g., random access memory, read-only memory, etc.), magnetic storage, volatile storage, non-volatile storage, optical storage, DVD, CD, floppy disk drive, and the like. The memory 320 may also include one or more external storage devices or remotely located storage devices. The memory 320 may contain instructions and data as follows:
an operating system 108;
an application 112;
an instrumentation tool 114;
one or more user interaction logs 116; and
various other applications and data 326.

FIG. 14 illustrates a block diagram of an exemplary server device 106. The server device 106 may have one or more processors 324, a display 326, a network interface 328, a memory 330, and a user input interface 332. A processor 324 may be any commercially available processor and may include dual microprocessors and multi-processor architectures. The display 326 may be any type of visual display unit. The network interface 328 facilitates wired or wireless communications between the server device 106 and a communications framework. The user input interface 332 facilitates communications between the server device 106 and input devices, such as a keyboard, mouse, etc.

The memory 330 may be any computer-readable storage media that may store executable procedures, applications, and data. The computer-readable media does not pertain to propagated signals, such as modulated data signals transmitted through a carrier wave. It may be any type of memory device (e.g., random access memory, read-only memory, etc.), magnetic storage, volatile storage, non-volatile storage, optical storage, DVD, CD, floppy disk drive, and the like. The memory 330 may also include one or more external storage devices or remotely located storage devices. The memory 330 may contain instructions and data as follows:
an operating system 108;
one or more user interaction logs 118;
one or more detectors 120A-120N;
an analytic engine 122;
input data 124A-124N;
output, 126A-126N;
a fact file 128; and
various other applications and data 336.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A computer-implemented method for analyzing usage of an application, comprising:
formulating a sequence of user actions from a trace of the application, the user actions representing executed command invocations and window focus changes made by the user while using a feature of the application;
executing one or more detectors, each detector matching a sequence of user actions against a known pattern associated with a detector, the known pattern including one or more user actions;
associating a feature-level usage analytic when a sequence of user actions matches a known pattern of a detector, the feature-level usage analytic identifying a common trait amongst users that perform a same sequence of user actions; and
outputting the feature-level usage analytic.

2. The computer-implemented method of claim 1,
wherein a known pattern of a detector indicates a time threshold as to when one or more user actions are to occur.

3. The computer-implemented method of claim 1,
wherein a known pattern of a detector indicates a frequency threshold as to how often one or more user actions are to occur.

4. The computer-implemented method of claim 1, wherein the feature-level usage analytic is an adoption state that indicates an outcome of a group of users' usage with a feature.

5. The computer-implemented method of claim 1, wherein the feature-level usage analytic indicates a level of a group of users' ability with the application.

6. The computer-implemented method of claim 4, further comprising:
providing a first detector that generates an application state of adoption of a first feature when a sequence of user actions indicates usage of the first feature in an intended manner.

7. The computer-implemented method of claim 4, further comprising:
providing a second detector that generates an application state of error message abandonment of a second feature when a sequence of user actions indicates a user executing a feature followed by user actions indicative of an error in execution of the user actions followed by the user abandoning the feature.

8. The computer-implemented method of claim 4, further comprising:
providing a third detector that generates an application state of interruption of a third feature when a sequence of user actions indicates a user executing a feature followed by user actions indicative of the user being interrupted.

9. The computer-implemented method of claim 4, further comprising:
providing a fourth detector that generates an application state of misadoption of a fourth feature when a sequence of user actions indicates a user executing a feature followed by user actions indicative of the user not executing the feature within predetermined time thresholds.

10. The computer-implemented method of claim 4, further comprising:
providing a fifth detector that analyzes a user's user actions from one or more user sessions to associate an application state with a sequence of user actions.

11. A computer-readable storage medium storing thereon processor-executable instructions for analyzing usage of an application, comprising:
one or more user interaction logs, each user interaction log having a trace of one or more user actions performed by a user while using the application, each user action associated with a command invocation or window focus change associated with a feature of the application; and
an analytic engine, having instructions that when executed on a processor,
generates a sequence of user actions for each user from the plurality of user interaction logs, the sequence of user actions configured in increasing chronological order,
matches the sequence with a known pattern of user actions and applies a feature-level usage analytic to the sequence, the feature-level usage analytic identifying a common trait amongst users that perform a same sequence of user actions, and
outputs the feature-level usage analytic.

12. The computer-readable storage medium of claim 11, wherein the feature-level usage analytic represents a level of a user's ability with the application.

13. The computer-readable storage medium of claim 11,
wherein the feature-level usage analytic represents an adoption state associated with a degree to which a group of users adopt a feature.

14. The computer-readable storage medium of claim 13,
wherein the application state may include abandonment or adoption of a feature of the application.

15. A system for analyzing a user's interaction with an application, comprising:
a server having a processor and a memory, the memory containing instructions, that when executed on a processor, detects a known pattern of user actions against a sequence of user actions, the sequence of user actions representing at least one command invocation or window focus change made by a user during execution of a feature of an application, the known pattern having one or more user actions that infer a feature-level usage analytic when user actions in the sequence match user actions in the known pattern, and the memory containing instructions, that when executed on a processor, uses the sequence of user actions and feature-level usage analytics to analyze usage of the application.

16. The system of claim 15, the memory containing further instructions, that when executed on a processor, represents a known pattern of user actions as a sequence of instructions that detect user actions indicative of a user executing a feature in an intended manner and indicative of adoption of the feature.

17. The system of claim 15, the memory containing further instructions, that when executed on a processor, represents a known pattern of user actions as a sequence of instructions that detect user actions indicative of a user executing a feature which the user subsequently abandons.

18. The system of claim 15, the memory containing further instructions, that when executed on a processor, represents a known pattern of user actions as a sequence of instructions that detect user actions indicative of a user executing a feature followed by user actions indicative of the user being interrupted.

19. The system of claim 15, the memory containing further instructions, that when executed on a processor, represents a known pattern of user actions as a sequence of instructions that detect user actions indicative of a user executing a feature followed by user actions indicative of an error in execution of the user actions followed by the user abandoning the feature.

20. The system of claim 15, the memory containing further instructions, that when executed on a processor, represents a known pattern of user actions as a sequence of instructions that detect user actions indicative of a level of a user's ability with the application.
